(19) United States
(12) Patent Application Publication
(10) Pub. No.: US 2024/0199079 A1
(43) Pub. Date: Jun. 20, 2024

(54) PREDICTING THE FURTHER DEVELOPMENT OF A SCENARIO WITH AGGREGATION OF LATENT REPRESENTATIONS

(71) Applicant: Robert Bosch GmbH, Stuttgart (DE)

(72) Inventors: Max Keller, Korntal-Muenchingen (DE); Faris Janjos, Stuttgart (DE); Maxim Dolgov, Renningen (DE)

(21) Appl. No.: 18/527,630

(22) Filed: Dec. 4, 2023

(30) Foreign Application Priority Data
Dec. 15, 2022 (DE) 10 2022 213 710.8

(51) Int. Cl. B60W 60/00; B60W 50/00

(52) U.S. Cl. CPC B60W 60/0016; B60W 50/0097; B60W 2554/404

(57) ABSTRACT

A method for predicting a future state and/or behavior of a scenario whose further development is correlated with one or more observable variables, without directly and unambiguously arising from these observable variables. In the method: measured observations of the observable variables at current points in time are processed using an encoder to form context representations; the context representations are processed using a specified processing function to form processing products; predictions for context representations of the scenario at future points in time are determined using a context predictor on the basis of at least the processing products as the sought-after prediction of the future state and/or behavior; wherein the processing function is designed to aggregate context representations from a specified time horizon prior to a point in time to form the processing product.

### CROSS REFERENCE

The present application claims the benefit under 35 U.S.C. § 119 of German Patent Application No. DE 10 2022 213 710.8 filed on Dec. 15, 2022, which is expressly incorporated herein by reference in its entirety.

### FIELD

The present invention relates to the prediction of a future state and/or behavior of a scenario, which can be used, for example, for the trajectory planning of vehicles.

### BACKGROUND INFORMATION

In order to be able to plan maneuvers that are safe and comprehensible, automated vehicles must anticipate how the situation in which they find themselves will develop. For this purpose, future trajectories of other road users (vehicles, cyclists, pedestrians) are predicted and passed on to the planning components. Traditional prediction methods generally perform prediction based on dynamics and can only model the interactions between road users to a limited extent. For this reason, the use of machine learning, in particular deep learning (DL), has established itself in recent years as the de facto standard for prediction.

The time horizon is crucial for prediction. A precise long-term prediction allows the planning component to plan the respective driving behavior for the various possible developments of the scenario at an early stage. Such anticipatory planning enables safer, more efficient and more comfortable driving behavior since spontaneous changes to the planned driving behavior can be avoided. A short-term prediction, on the other hand, often has the consequence that spontaneous changes are necessary to ensure the safety of the road users. Spontaneous changes in driving behavior include, for example, abrupt braking, unplanned lane changes and short-term evasive maneuvers.

### SUMMARY

The present invention provides a method for predicting a future state and/or behavior of a scenario on the basis of measured observations of observable variables. In this case, the further development of the scenario is correlated with one or more observable variables, without directly and unambiguously arising from these observable variables.

One example of such scenarios is traffic situations with a plurality of participants. Such situations can be observed, for example, by monitoring the environment of a vehicle that drives in an at least partially automated manner, using cameras, radar, lidar, ultrasound and other sensors. The further development of the traffic situation does not directly and unambiguously arise from these observations since the individual road users each act autonomously. However, the further development is correlated with the observations at least in the sense that the observations respectively exclude certain further developments. For example, road users cannot suddenly disappear or jump from one side of the scenario to the other.

According to an example embodiment of the present invention, the method begins by processing measured observations Oₜ of the observable variables at current points in time t with an encoder ϕ to form context representations Zₜ. These context representations Zₜ can, for example, in particular belong to a space that has a significantly lower dimensionality than the space of the measured observations Oₜ. For example, images or even time series of measurement data can be processed as measured observations Oₜ using a convolutional neural network as an encoder ϕ. A convolutional neural network applies filter kernels to the data in a plurality of convolutional layers, wherein the filter kernel is shifted to a large number of positions within the data, and these positions are arranged in a predetermined grid. This produces a numerical value for each position of the filter core, and the numerical values for all positions are summarized in a feature map. The feature maps can optionally be further summarized by pooling operations. The final result is characterized by significantly fewer independent numerical values than the original measured observations Oₜ. In general, for example, a multi-layer perceptron (MLP) can be used as an encoder ϕ.

According to an example embodiment of the present invention, the context representations Zₜ are processed using a specified processing function γ to form processing products Zₜ. Predictions \hat{Z}_{τ} for context representations Z_{τ} of the scenario at future points in time τ are then determined using a context predictor ψ on the basis of at least the processing products Zₜ as the sought-after prediction of the future state and/or behavior.

The processing function γ is designed to aggregate context representations Zₜ from a specified time horizon prior to point in time t to form the processing product Zₜ. This time horizon can, for example, in particular comprise all context representations Zₜ formed prior to point in time t. However, the time horizon can also be limited depending on the application.

This aggregation has the advantageous effect that work results that have already been formed in the past and contain knowledge about possible further developments of the scenario are utilized optimally. Thus, the ultimately formed prediction of the future state and/or behavior is based on all available indications of the further development. Therefore, it is much more accurate than if it were based only on the most recent context representation Zₜ, for example. This is somewhat analogous to the fact that solutions in written examinations that do not use all the information given in the task are rarely correct.

At the same time, every time a new prediction \hat{Z}_{τ} is formed, the computing effort invested so far is used again and again. Nothing that has already been calculated is recalculated. At the same time, it is not necessary to save all previous calculation results, wherein the memory requirements would quickly get out of hand. Instead, aggregation can work in the same way as a progress table, in which only the immediately preceding row needs to be kept at all times.

The method of the present invention makes use of prior knowledge that is encoded in the encoder ϕ, in the processing function γ, and/or in the context predictor ψ. The encoder ϕ, the processing function γ and/or the context predictor ψ can, for example, in particular be designed as trainable machine learning models, such as neural networks.

In principle, aggregation can be directly integrated into the determination of the predictions \hat{Z}_{τ} for context representations Z_{τ} of the scenario at future points in time τ. However, it has been recognized that this is only possible at the cost that the provided predictions \hat{Z}_{τ} are then also aggregated over a plurality of future points in time τ. Thus, shifting the aggregation to the processing function γ according to the method proposed here has the effect that the provided predictions \hat{Z}_{τ} only ever refer to individual points in time t.

This facilitates the monitored training of machine learning models that are to be used as context encoders ϕ, as processing function γ, and/or as context predictors ψ. Such monitored training can, for example, include comparing the predictions \hat{Z}_{τ} determined using the models to be trained with observations Oₜ actually measured at later points in time t. However, such actually measured observations Oₜ are difficult to compare with predictions \hat{Z}_{τ} that are aggregated over a plurality of points in time τ. This is somewhat analogous to comparing a voltage of 5 volts with a current of 5 amperes.

In particular, such monitored training requires that predictions \hat{Z}_{τ}, which are aggregated over a plurality of points in time τ, can at least be reconstructed to form predictions Ô_{τ} for observations O_{τ}, which are aggregated over the same points in time t, so that the comparison with actually measured observations Oₜ can then take place in the space of these observations O_{τ}. The mapping of the encoder ϕ, which leads from the space of observations Oₜ into the space of context representations Zₜ, must therefore be reversible in a meaningful way. This restricts the selection of usable spaces of context representations Zₜ. The method proposed here, on the other hand, provides predictions \hat{Z}_{τ} that refer to individual, non-aggregated points in time τ, and is not subject to the aforementioned restriction. Thus, it is also possible to use spaces of context representations Zₜ, into which one can map only in one direction based on the actually measured observations Oₜ, without a meaningful return path. Hash functions are an extremely vivid example of encoders ϕ that can do this. Hash functions condense the observations Oₜ very strongly to form context representations Zₜ, which do not allow any conclusions to be drawn about the original observations Oₜ. This is somewhat analogous to hashing passwords. This cannot be inverted directly but can only be inverted by hashing candidates for the password.

According to an example embodiment of the present invention, the processing function γ can in particular be implemented as a recurrent neural network, RNN, for example. Such a network is particularly well suited to continuously aggregate new context representations Zₜ, since it has a way to store its output for later reuse.

In a particularly advantageous embodiment of the present invention, the processing function γ is additionally designed to include predictions \hat{Z}_{τ} from the specified time horizon in the formation of the processing product Zₜ. In this way, the processing function γ becomes autoregressive. This means that it also utilizes the predictions of the future state and/or behavior of the scenario already provided by the method for new predictions. This further use of the work results already achieved makes the predictions even more accurate.

In a further advantageous embodiment of the present invention, the context predictor ψ is additionally designed to include further data Aₜ available at point in time t in the formation of the predictions \hat{Z}_{τ} for context representations. These data Aₜ can represent any further additional information about the scenario. Any such additional information can further improve the accuracy of the prediction obtained.

In a further, particularly advantageous embodiment of the present invention, predictions Ô_{τ} for observations O_{τ} of the observable variables at the points in time τ are reconstructed from the predictions \hat{Z}_{τ} for context representations Z_{τ} of the scenario, as a further part of the sought-after prediction of the future state and/or behavior. These predictions Ô_{τ} are directly comparable with observations Oₜ actually measured later in the temporal connection at the points in time τ.

Thus, in a further, particularly advantageous embodiment of the present invention, predictions Ô_{τ} for observations O_{τ} of the observable variables, and/or predictions \hat{Z}_{τ} for context representations Z_{τ} of the scenario, are checked for plausibility against later measured observations Oₜ in the temporal connection with the points in time τ. Here, the plausibility check of two variables against one another in particular means, for example, that the value of one variable is in each case realistic in the light of the value of the other variable. A direct comparison, or direct comparability, of the two variables is not required for this purpose. In particular, the two variables can, for example, be assessed as not plausible in relation to one another if, in the context of the present application, the value of the one variable represents a contradiction in light of the value of the other variable. If, for example, according to the predictions Ô_{τ}, an object should be present at a certain point in a traffic situation but, according to the later measured observations Oₜ, this object is actually not present, the predictions Ô_{τ} are not plausible in relation to the later observations Oₜ.

Thus, the plausibility check does not require that predictions Ô_{τ} for observations O_{τ} of the observable variables can be determined at all from predictions \hat{Z}_{τ} for context representations Z_{τ} of the scenario. Instead, the plausibility check can be carried out directly in the space of predictions \hat{Z}_{τ}.

Thus, in a further, particularly advantageous embodiment of the present invention, the plausibility check includes processing the later measured observations Oₜ with the encoder ϕ to form context representations Zₜ. Such context representations Zₜ are then compared with the predictions \hat{Z}_{τ} for context representations Z_{τ}. This is somewhat analogous to the previously mentioned authentication with hashed passwords, with which a hash value of the password entered by the user is compared with a stored hash value.

In a particularly advantageous embodiment of the present invention, a scenario that is characterized by the movement of road users, pedestrians, animals or other autonomous agents is selected. As explained above, observations of such scenarios can provide indications of their further development and rule out certain further developments (such as the sudden disappearance of objects). However, the further development cannot directly and unambiguously arise from the observations since the intentions of the autonomous agents involved cannot be fully detected by the observations.

In a further, particularly advantageous embodiment of the present invention, at least one trajectory r of an autonomous agent of the scenario, and/or a space Q occupied by at least one autonomous agent in the scenario, as a function of time, is evaluated from the determined prediction of the future state and/or behavior. This information is particularly valuable for planning the future behavior of a vehicle or robot driving in an at least partially automated manner, while avoiding collisions with the other agents in the scenario. As mentioned at the beginning, the improved long-term prediction makes it possible to avoid spontaneous changes in driving behavior, which are associated with a significant loss of comfort and can possibly also lead to rear-end collisions with the controlled vehicle.

In addition to the determined prediction of the future state and/or behavior, any further information sources, such as previous or past trajectories r′, or already determined processing products Zₜ, can be used to predict the trajectory.

For example, according to an example embodiment of the present invention, a region frequented by a large number of people can also be observed in order to use the method described here to predict whether dangerous congestion is imminent at any point in the region and whether people could be injured (e.g., crushed or trampled on) by the crowd. If the determined prediction indicates such a danger, entrances can be closed automatically, for example, in order to prevent a further influx of people. Emergency exits or other doors can also be opened, for example, in order to provide relief.

For example, according to an example embodiment of the present invention, the region in front of a vehicle to be controlled can also be observed, and it is possible to predict what will be seen in a region that is currently still hidden (such as behind a road corner or bend) when the vehicle to be controlled reaches a position from which this region can be viewed. If, for example, it can be predicted on the basis of current observations Oₜ that another road user is concealed in this region, it is possible to react to this at an early stage and, for example, gently brake the vehicle to be controlled, instead of having to do this suddenly and abruptly at a later point in time.

Thus, in a further, particularly advantageous embodiment of the present invention, a control signal is formed from the determined prediction of the future state and/or behavior, from the result of the plausibility check, from the evaluated trajectory r, and/or from the evaluated occupied space Q. A vehicle, a robot, a driving assistance system and/or a system for monitoring regions is controlled with the control signal. In this context, the improved accuracy with which the future state and/or behavior of the scenario can be predicted has the effect that the reaction of the respective controlled system to the control signal matches the respective scenario with a higher probability.

The present invention also relates to a method for training a context encoder ϕ, a processing function γ, and/or a context predictor ψ, for use in the above-described method according to the present invention for predicting a future state and/or behavior of a scenario.

According to an example embodiment of the present invention, as part of this method, measured observations Oₜ of the observable variables at points in time t in a specified measurement time horizon t≤M are provided. A subset of observations in a specified test time horizon t≤T with T<M is selected from these measured observations Oₜ. Based on this subset of the measured observations Oₜ, a prediction of the future state and/or behavior of a scenario is determined with the previously described method using the context encoder ϕ to be trained, the processing function γ to be trained, and/or the context predictor ψ to be trained.

According to an example embodiment of the present invention, a specified cost function L (also called a loss function) is used to assess how well this prediction, and/or at least one subsequent result determined from this prediction, is consistent with the observations Oₜ in the time horizon T<t≤M. This means that the later observations Oₜ are used to check the prediction made on the basis of the earlier observations Oₜ.

According to an example embodiment of the present invention, parameters P, which characterize the behavior of the context encoder ϕ, the processing function γ or the context predictor ψ are optimized with the aim of improving the assessment by the cost function L as predictions of the future state and/or behavior continue to be determined. In particular, these parameters can comprise, for example, weights that are used to sum up inputs that to a neuron or another processing unit of a neural network to activate this neuron or this processing unit. Any suitable optimization method can be used for optimization. For example, gradients of the cost function L can be formed according to the parameters, and the parameters can be changed in the direction of these gradients.

According to an example embodiment of the present invention, how well the prediction is consistent with the later observations Oₜ in the time horizon T<t≤M can be measured in any way according to the above, even without a direct comparison of the prediction with the observations Oₜ. For example, any criteria can be used to detect the extent to which there are contradictions between the prediction and the later observations Oₜ, such as with regard to the presence or absence of objects.

In a particularly advantageous embodiment of the present invention, the cost function L measures distances between observations Oₜ on the one hand and predictions Ô_{τ} for observations O_{τ} on the other hand. This is a particularly insightful measure for the case that predictions Ô_{τ} for observations O_{τ} can be reconstructed from predictions \hat{Z}_{τ} for context representations Z_{τ} of the scenario.

In a further, particularly advantageous embodiment of the present invention, the later observations Oₜ in the time horizon T<t≤M are processed using the context encoder ϕ to form context representations Zₜ. The cost function L measures distances between these context representations Zₜ on the one hand and predictions \hat{Z}_{τ} for context representations Z_{τ} on the other hand. In this way, the comparison between the predictions \hat{Z}_{τ} for context representations Z_{τ} and the later observations Oₜ can be shifted into the latent space of the predictions \hat{Z}_{τ}. This is in particular advantageous, for example, if
differences relevant to the respective application are particularly evident in this space, or
there is only a mapping from the space of observations Oₜ into the space of predictions \hat{Z}_{τ}, but no mapping in the opposite direction.

Furthermore, according to an example embodiment of the present invention, the formation of the context representations Zₜ can also act as a filter that summarizes relevant parts of the measured observations Oₜ in the compact context representations Zₜ for the specified application and ignores irrelevant parts of the measured observations Oₜ. By comparing the predictions \hat{Z}_{τ} for context representations Z_{τ} and the later observations Oₜ in the latent space of the predictions \hat{Z}_{τ}, only parts of the data that have already been identified as relevant are thus compared with one another. If, on the other hand, predictions Ô_{τ} for later observations O_{τ} are reconstructed from predictions \hat{Z}_{τ} for context representations \hat{Z}_{τ}, less relevant parts can also reappear through this reconstruction.

This can be illustrated using the example of lidar observations, which are available as point clouds. If only a part of this point cloud is actually relevant for predicting the future state or behavior of the scenario, the encoder ϕ will learn to encode only these parts of the point cloud into the context representations Z_{τ}. Accordingly, the cost function L only determines a learning signal from these parts. However, a reconstruction of the point cloud from predictions \hat{Z}_{τ} for context representations Z_{τ} will not simply have gaps at the locations previously identified as less relevant, but will be filled with something. If a learning signal is also derived from these parts of the reconstructed point cloud, this can reduce the overall accuracy ultimately achieved.

The methods of the present invention described herein can be fully or partially computer-implemented and thus embodied in software. The present invention therefore also relates to one or more computer programs comprising machine-readable instructions that, when executed on one or more computers and/or compute instances, cause the computer (s) and/or compute instance (s) to perform one of the described methods. In this sense, control devices for vehicles and embedded systems for technical devices, which are also capable of executing machine-readable instructions, are to be regarded as computers. Compute instances can be virtual machines, containers or serverless execution environments, for example, which can be provided in a cloud in particular.

The present invention also relates to a machine-readable data carrier and/or a download product with the one or more computer programs. A download product is a digital product that can be transmitted via a data network, i.e., can be downloaded by a user of the data network, and that can be offered for immediate downloading in an on-line store, for example.

Furthermore, one or more computers and/or compute instances can be equipped with the one or more computer programs, with the machine-readable data carrier or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for predicting a future state and/or behavior of a scenario, according to the present invention.

FIG. 2 shows an exemplary embodiment of the method 200 according to the present invention for training a context encoder ϕ, a processing function γ, and/or a context predictor ψ, for use in the method 100 according to the present invention.

### DETAILED DESCRIPTION OF EXAMPLE EMBODIMENTS

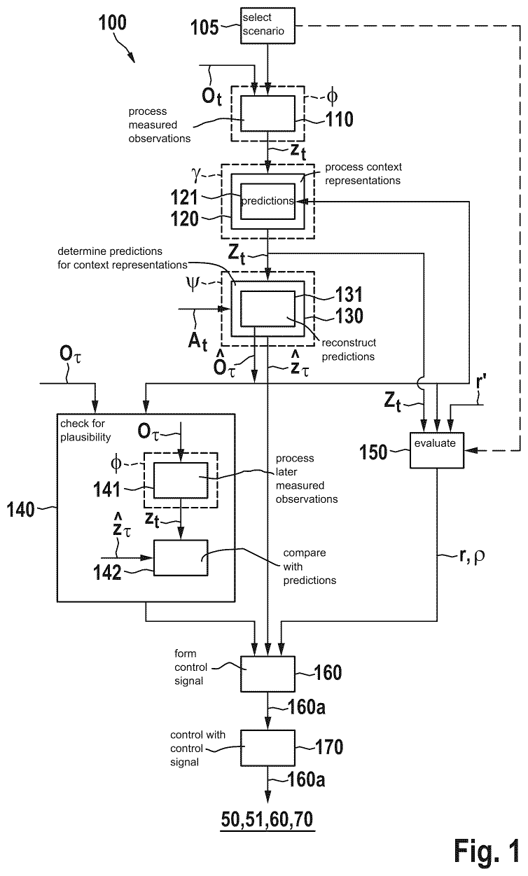

FIG. 1 is a schematic flow chart of an exemplary embodiment of the method 100 for predicting a future state and/or behavior of a scenario on the basis of measured observations Oₜ.

In step 110, measured observations Oₜ of the observable variables at current points in time t are processed using an encoder ϕ to form context representations Zₜ, which can in particular, for example, have a lower dimensionality than the original observations Oₜ.

In step 120, the context representations Zₜ are processed using a specified processing function γ to form processing products Zₜ. This processing function γ is designed to aggregate context representations Zₜ from a specified time horizon prior to point in time t to form the processing product Zₜ.

According to block 121, the processing function γ can additionally be designed to include predictions \hat{Z}_{τ} from the specified time horizon in the formation of the processing product Zₜ.

In step 130, predictions \hat{Z}_{τ} for context representations z, of the scenario at future points in time τ are determined using a context predictor ψ on the basis of at least the processing products Zₜ as the sought-after prediction of the future state and/or behavior. Optionally, further data Aₜ can also be included here.

According to block 131, predictions Ô_{τ} for observations O_{τ} of the observable variables at the points in time τ can be reconstructed from the predictions \hat{Z}_{τ} for context representations Z_{τ} of the scenario, as a further part of the sought-after prediction of the future state and/or behavior.

In step 140, predictions Ô_{τ} for observations O_{τ} of the observable variables, and/or predictions \hat{Z}_{τ} for context representations Z_{τ} of the scenario, are checked for plausibility against later measured observations Oₜ in the temporal connection with the points in time τ.

In particular, this can include, for example, processing the later measured observations Oₜ using the encoder ϕ to form context representations Zₜ according to block 141. According to block 142, these context representations Zₜ can then be compared with the predictions \hat{Z}_{τ} for context representations Z_{τ}.

Insofar as, according to block 105, a scenario has been selected that is characterized by the movement of road users, pedestrians, animals or other autonomous agents, at least one trajectory r of an autonomous agent of the scenario and/or a space Q occupied by at least one autonomous agent in the scenario, as a function of time is evaluated in step 150 from the determined prediction of the future state and/or behavior. As explained above, any other information sources, such as previously determined processing products Zₜ or past trajectories r′, can also be used. In this way, a trajectory r that is possibly more plausibly based on the past trajectory r′ or otherwise connects to the past in a meaningful way can be predicted.

In step 160, a control signal 160a is formed from the determined prediction of the future state and/or behavior (here in the form of predictions \hat{Z}_{τ} for context representations Z_{τ} of the scenario and/or predictions Ô_{τ} for observations O_{τ} of the observable variables), from the result of the plausibility check, from the evaluated trajectory r, and/or from the evaluated occupied space Q.

In step 170, a vehicle 50, a robot 51, a driving assistance system 60, and/or a system 70 for monitoring regions is controlled with the control signal 160a.

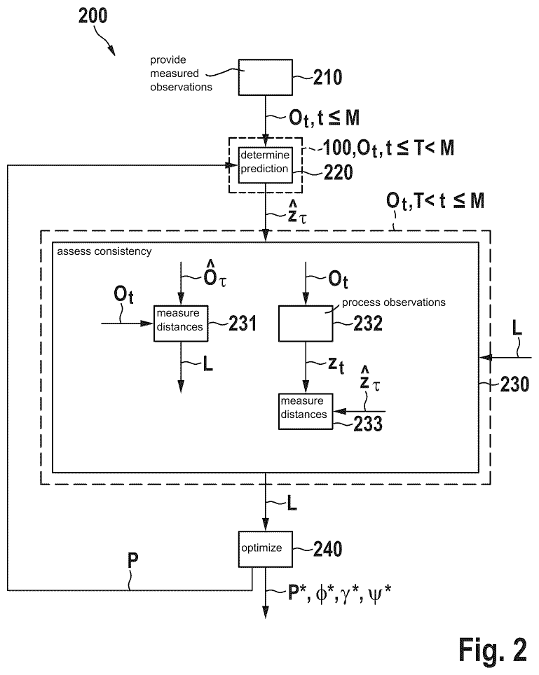

FIG. 2 is a schematic flow chart of an exemplary embodiment of the method 200 for training a context encoder ϕ, a processing function γ, and/or a context predictor ψ, for use in the previously described method 100.

In step 210, measured observations Oₜ of the observable variables at points in time t in a specified measurement time horizon t≤M are provided.

In step 220, based on a subset of the measured observations Oₜ in a specified test time horizon t≤T with T<M, the method 100 is used to determine a prediction of the future state and/or behavior of a scenario, here in the form of predictions \hat{Z}_{τ} for context representations Z_{τ} of the scenario.

In step 230, a specified cost function L is used to assess how well this prediction, and/or at least one subsequent result determined from this prediction, is consistent with the observations Oₜ in the time horizon T<t≤M.

According to block 231, the cost function L can, for example, measure distances between observations Oₜ on the one hand and predictions Ô_{τ} for observations O_{τ} on the other hand.

According to block 232, observations Oₜ in the time horizon T<t≤M can be processed using the context encoder ϕ to form context representations Zₜ. Then, according to block 233, the cost function L can measure distances between these context representations Zₜ on the one hand and predictions \hat{Z}_{τ} for context representations Z_{τ} on the other hand.

In step 240, parameters P that characterize the behavior of the context encoder ϕ, the processing function γ or the context predictor ψ are optimized with the aim of improving the assessment by the cost function L as predictions of the future state and/or behavior continue to be determined. The fully optimized state of these parameters P is designated by reference sign P*. Accordingly, the finished states of the context encoder ϕ, the processing function γ and the context predictor ψ are designated by reference signs ϕ*, γ* and ψ* respectively.

The training can in particular also be combined, for example, with the training of downstream systems that determine further predictions, for example predictions of trajectories, on the basis of the predicted state and/or behavior of the scenario. The training can, for example, be fully or partially “end-to-end” in the sense that the cost function L also measures how good the final result determined by downstream systems is. For example, certain types of errors and inaccuracies in the prediction of the state and/or behavior may have a greater impact on said final result than others.

What is claimed is:

1. A method for predicting a future state and/or behavior of a scenario whose further development is correlated with one or more observable variables, without directly and unambiguously arising from the observable variables, comprising the following steps of:
processing measured observations of the observable variables at a current points in time t using an encoder to form context representations of the scenario;
processing the context representations using a specified processing function to form processing products;
determining predictions for the context representations of the scenario at future points in time t using a context predictor based on at least the processing products as the prediction of the future state and/or behavior;
wherein the specified processing function is configured to aggregate the context representations from a specified time horizon prior to the point in time t to form the processing product.

2. The method according to claim 1, wherein the processing function is additionally configured to include predictions from the specified time horizon in the formation of the processing product.

3. The method according to claim 1, wherein the context predictor is additionally configured to include further data present at the point in time in the formation of the predictions for the context representations.

4. The method according to claim 1, wherein predictions for observations of the observable variables at the further points in time t are reconstructed from the predictions for the context representations of the scenario, as a further part of the prediction of the future state and/or behavior.

5. The method according to claim 1, wherein the predictions for observations of the observable variables, and/or the predictions for the context representations of the scenario, are checked for plausibility against later measured observations in temporal connection with the future points in time t.

6. The method according to claim 5, wherein the plausibility check includes:
processing the later measured observations using the encoder to form further context representations, and
comparing the further context representations with the predictions for the context representations.

7. The method according to claim 5, wherein the scenario is characterized by the movement of: road users or pedestrians or animals or other autonomous agents.

8. The method according to claim 7, wherein at least one trajectory of an autonomous agent of the scenario, and/or a space occupied by at least one autonomous agent in the scenario, as a function of time, is evaluated from the determined prediction of the future state and/or behavior.

9. The method according to claim 8, wherein:
a control signal is formed: from the determined prediction of the future state and/or behavior, and/or from a result of the plausibility check, and/or from the evaluated trajectory r, and/or from the evaluated occupied space; and
a vehicle and/or a robot and/or a driving assistance system and/or a system for monitoring regions, is controlled with the control signal.

10. A method for training a context encoder and/or a processing function and/or a context predictor, for predicting a future state and/or behavior of a scenario, comprising the following steps:
providing measured observations Oₜ of observable variables at points in time t in a specified measurement time horizon t≤M;
based on a subset of the measured observations Oₜ in a specified test time horizon t≤T with T<M, determining a prediction of a future state and/or behavior of a scenario;
assessing, using a specified cost function, how well the prediction of the future state and/or behavior, and/or at least one subsequent result determined from the prediction of the future state and/or behavior, is consistent with the observations in the time horizon T<t≤M; and
optimizing parameters which characterize a behavior of the context encoder and/or the processing function and/or the context predictor with a goal of improving the assessment by the cost function as predictions of the future state and/or behavior continue to be determined.

11. The method according to claim 10, wherein the prediction of the future state and/or behavior of the scenario is determined by:
processing the subset of the measured observations at a current points in time t using the encoder to form context representations of the scenario;
processing the context representations using the processing function to form processing products;
determining predictions for the context representations of the scenario at future points in time t using the context predictor based on at least the processing products as the prediction of the future state and/or behavior;
wherein the processing function is configured to aggregate the context representations from a specified time horizon prior to the point in time t to form the processing product.

12. The method according to claim 10, wherein the cost function measures distances between observations on the one hand and predictions for observations on the other hand.

13. The method according to claim 11, wherein:
the measured observations in a time horizon T<t≤M are processed using the context encoder to form the context representations; and
the cost function measures distances between the context representations on the one hand and the predictions for the context representations on the other hand.

14. A non-transitory machine-readable data carrier on which is stored one or more computer programs for predicting a future state and/or behavior of a scenario whose further development is correlated with one or more observable variables, without directly and unambiguously arising from the observable variables, the one or more computer programs, when executed by one or more computers and/or compute instances, cause the one or more computers and/or compute instances to perform the following steps of:
processing measured observations of the observable variables at a current points in time t using an encoder to form context representations of the scenario;
processing the context representations using a specified processing function to form processing products;
determining predictions for the context representations of the scenario at future points in time t using a context predictor based on at least the processing products as the prediction of the future state and/or behavior;
wherein the specified processing function is configured to aggregate the context representations from a specified time horizon prior to the point in time t to form the processing product.

15. One or more computers and/or compute instances configured to predict a future state and/or behavior of a scenario whose further development is correlated with one or more observable variables, without directly and unambiguously arising from the observable variables, the one or more computers and/or compute instances configured to:
process measured observations of the observable variables at a current points in time t using an encoder to form context representations of the scenario;
process the context representations using a specified processing function to form processing products;
determine predictions for the context representations of the scenario at future points in time τ using a context predictor based on at least the processing products as the prediction of the future state and/or behavior;
wherein the specified processing function is configured to aggregate the context representations from a specified time horizon prior to the point in time t to form the processing product.
